(19) United States
(12) Patent Application Publication
(10) Pub. No.: US 2010/0295282 A1
(43) Pub. Date: Nov. 25, 2010

(54) SEAT WITH SIDE AIRBAG FOR VEHICLES

(75) Inventors: YEONG UK KIM, HWASEONG-SI (KR); SANG HO KIM, INCHEON-SI (KR); DAE YOUNG KWAK, YONGIN-SI (KR); JAE YOUNG KIM, ULSAN-SI (KR)

Correspondence Address: MORGAN, LEWIS & BOCKIUS LLP (SF), One Market, Spear Street Tower, Suite 2800, San Francisco, CA, 94105, US

(73) Assignees: HYUNDAI MOTOR COMPANY, SEOUL (KR); KIA MOTORS CORPORATION, SEOUL (KR)

(21) Appl. No.: 12/613,793

(22) Filed: Nov. 6, 2009

(30) Foreign Application Priority Data
May 21, 2009 (KR) 10-2009-0044384
May 21, 2009 (KR) 10-2009-0044385
Jul. 15, 2009 (KR) 10-2009-0064398

(51) Int. Cl. B60R 21/20

(52) U.S. Cl. 280/730.2

(57) ABSTRACT

A seat with a side airbag for vehicles is disclosed, which is constructed such that an airbag cushion is deployed through a connection portion formed between a front seat cover and a side seat cover. A guide tape may be attached on the side seat cover. The guide tape extends a predetermined length in the longitudinal direction of the vehicle towards the connection portion between the front seat cover and the side seat cover.

### CROSS-REFERENCE TO RELATED APPLICATIONS

The present application claims priority to Korean Patent Application Number 10-2009-0044384 filed on May 21, 2009, Korean Patent Application Number 10-2009-0044385 filed on May 21, 2009, and Korean Patent Application Number 10-2009-0064398 filed on Jul. 15, 2009, the entire contents of which are incorporated herein for all purposes by this reference.

### BACKGROUND OF THE INVENTION

1. Field of the Invention

The present invention relates generally to seats with side airbags for vehicles and, more particularly, to a seat with a side airbag which is constructed such that the performance of tearing a connection portion formed between a front seat cover and a side seat cover can be enhanced.

2. Description of Related Art

Recently, the number of side airbags being installed to protect passengers from impacts between vehicle bodies and the passengers when the vehicles are in side collisions has increased. Such a side airbag must be constructed such that it can be smoothly deployed in the lateral direction of a side part of a seat.

However, in the case of seats with side airbags according to conventional techniques, because front and side seat covers comprise outer sheets and inner sheets, a seat pad or the side seat cover may excessively expand due to the inflation force of a deploying airbag cushion. In addition, the airbag may be inflated in a state in which a connection portion between the front and side seat covers fails to tear.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a seat with a side airbag which is constructed such that when an airbag is deployed, a side seat cover and a seat pad can be prevented from expanding, and the performance to tear a connection portion formed between the front seat cover and the side seat cover can be enhanced.

In an aspect of the present invention, a seat with a side airbag for a vehicle, may include a seat pad containing an airbag module therein, and a front seat cover for covering a front surface of the seat pad and a side seat cover for covering a lateral surface of the seat pad, wherein an airbag cushion contained in the airbag module is deployed through a connection portion coupling one end portions of the front seat cover and the side seat cover when the connection portion is disconnected by the airbag cushion, and wherein the front seat cover includes an inner sheet and an outer sheet covering the inner sheet, and the side seat cover includes a single outer sheet being brought into close contact with a lateral surface of the seat pad and fastened thereto by a fastening member, wherein the connection portion is formed at a corner of the seat pad in a forward direction of the seat, and wherein a notched portion is formed in the seat pad on a path along which the airbag cushion is deployed towards the connection portion, the notched portion guiding the airbag cushion such that the airbag cushion is deployed towards the connection portion through the notched portion.

The fastening member may include an adhesive layer or a Velcro tape coupling the seat pad and the single outer sheet of the side seat cover for preventing the seat pad or the seat cover from expanding due to lateral deployment force of the airbag cushion, wherein the Velcro tape is provided on the lateral surface of the seat pad or the single outer sheet of the side seat cover and extends in forward and rearward directions of the seat, and wherein the Velcro tape may include a plurality of Velcro tapes arranged in parallel to each other and spaced apart from each other at predetermined intervals with respect to a heightwise direction of the seat.

In another aspect of the present invention, a seat with a side airbag for a vehicle may include a seat pad containing an airbag module therein, and a front seat cover for covering a front surface of the seat pad and a side seat cover for covering a lateral surface of the seat pad, wherein an airbag cushion contained in the airbag module is deployed through a connection portion coupling one end portions of the front seat cover and the side seat cover when the connection portion is disconnected by the airbag cushion, and wherein a guide pad is integrally formed on the seat pad, the guide pad having an elongation ratio less than an elongation ratio of the seat pad, wherein the connection portion is formed at a corner of the seat pad in a forward direction of the seat, wherein the front seat cover may include an inner sheet and an outer sheet covering the inner sheet, and the side seat cover may include a single outer sheet, and the guide pad is provided on the lateral surface of the seat pad or inside the seat pad at a position facing the side seat cover, wherein the front seat cover may include an inner sheet and an outer sheet covering the inner sheet, and the side seat cover may include a single outer sheet, and the guide pad is provided on the lateral surface of the seat pad or inside the seat pad at a position facing the front seat cover, and wherein a notched portion is formed in the seat pad on a path along which the airbag cushion is deployed towards the connection portion, the notched portion guiding the airbag cushion such that the airbag cushion is deployed towards the connection portion through the notched portion.

In further another aspect of the present invention, a seat with a side airbag for a vehicle, may include a seat pad containing an airbag module therein, and a front seat cover for covering a front surface of the seat pad and a side seat cover for covering a lateral surface of the seat pad, wherein an airbag cushion contained in the airbag module is deployed through a connection portion coupling one end portions of the front seat cover and the side seat cover when the connection portion is disconnected by the airbag cushion, and wherein a guide tape is attached to the side seat cover to guide a direction in which the airbag cushion is deployed, the guide tape extending a predetermined length towards the connection portion in a longitudinal direction of a vehicle, wherein the connection portion is formed at a corner of the seat pad in a forward direction of the seat, and wherein a notched portion is formed in the seat pad on a path along which the airbag cushion is deployed towards the connection portion, the notched portion guiding the airbag cushion such that the airbag cushion is deployed towards the connection portion through the notched portion.

The front seat cover may include an inner sheet, and an outer sheet covering the inner sheet, and the side seat cover may include a single outer sheet made of non-woven fabric, and the guide tape may include a Velcro hook tape having a plurality of fine protruding hooks, so that the guide tape is in close contact with the single outer sheet of the side seat cover and is fastened thereto by the fine protruding hooks.

The front seat cover may include a single outer sheet, and the side seat cover may include a single outer sheet made of non-woven fabric, and the guide tape may include a Velcro hook tape having a plurality of fine protruding hooks, so that the guide tape is in close contact with the single outer sheet of the side seat cover and is fastened thereto by the fine protruding hooks, wherein the guide tape further includes a front guide tape attached to the front seat cover.

The side seat cover may further include a rear seat cover portion covering a rear surface of the seat pad, and the guide tape may further include a rear guide tape attached to the rear seat cover portion, the rear guide tape extending in a predetermined length along the rear surface of the seat pad, wherein the guide tape further may include a front guide tape attached to the front seat cover.

The guide tape may include a plurality of guide tapes attached to the side seat cover, the guide tapes being arranged parallel to each other and spaced apart from each other by predetermined intervals and in a heightwise direction of the seat pad.

The information disclosed in this Background of the Invention section is only for enhancement of understanding of the general background of the invention and should not be taken as an acknowledgement or any form of suggestion that this information forms the prior art already known to a person skilled in the art.

### BRIEF DESCRIPTION OF THE DRAWINGS

FIG. 1 is a view illustrating a seat with a side airbag for vehicles, according to a first exemplary embodiment of the present invention.

FIG. 2 is a sectional view taken along the line “A-A” of FIG. 1.

FIG. 3A is a sectional view of the portion “B” of FIG. 2.

FIG. 3B is a sectional view of the portion “C” of FIG. 2.

FIG. 4 is a sectional view taken along the line “A-A” of FIG. 1, according to a modification of the first exemplary embodiment of the present invention.

FIG. 5 is a view illustrating a seat with a side airbag for vehicles, according to a second exemplary embodiment of the present invention.

FIG. 6 is a sectional view taken along the line “A-A” of FIG. 5.

FIG. 7A is a sectional view of the portion “B” of FIG. 6.

FIG. 7B is a sectional view of the portion “C” of FIG. 6.

FIG. 8 is a sectional view taken along the line “A-A” of FIG. 5, according to a modification of the second exemplary embodiment of the present invention.

FIG. 9 is a sectional view taken along the line “A-A” of FIG. 5, according to another modification of the second exemplary embodiment of the present invention.

FIG. 10 is a view showing the coupling between a seat pad and a seat cover, according to a third exemplary embodiment of the present invention.

FIG. 11 is a view illustrating a seat with a side airbag for vehicles, according to the third exemplary embodiment of the present invention.

FIG. 12A is a sectional view of the portion “B” of FIG. 11.

FIG. 12B is a sectional view of the portion “C” of FIG. 11.

FIG. 13 is a sectional view of a seat with a side airbag, according to a modification of the third exemplary embodiment of the present invention.

FIG. 14 is a sectional view of a seat with a side airbag, according to another modification of the third exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, various exemplary embodiments of the present invention will be described in detail with reference to the attached drawings.

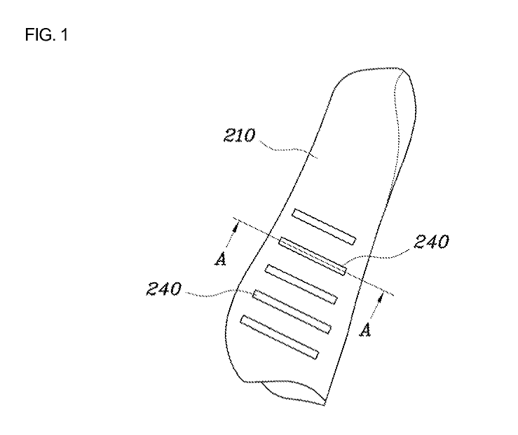

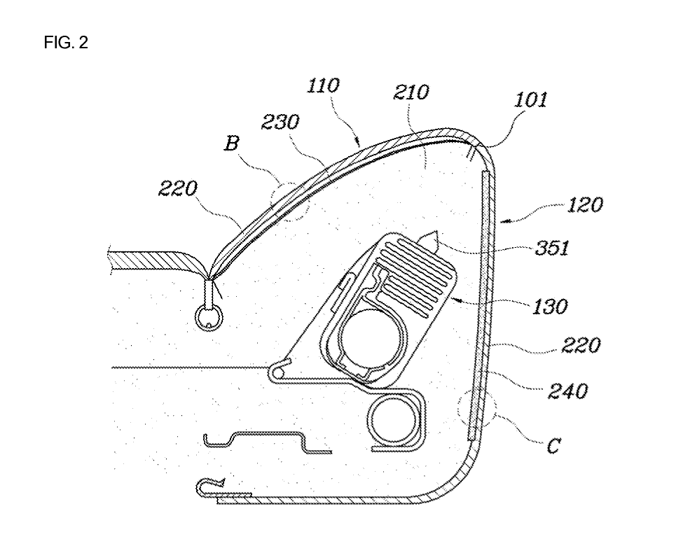

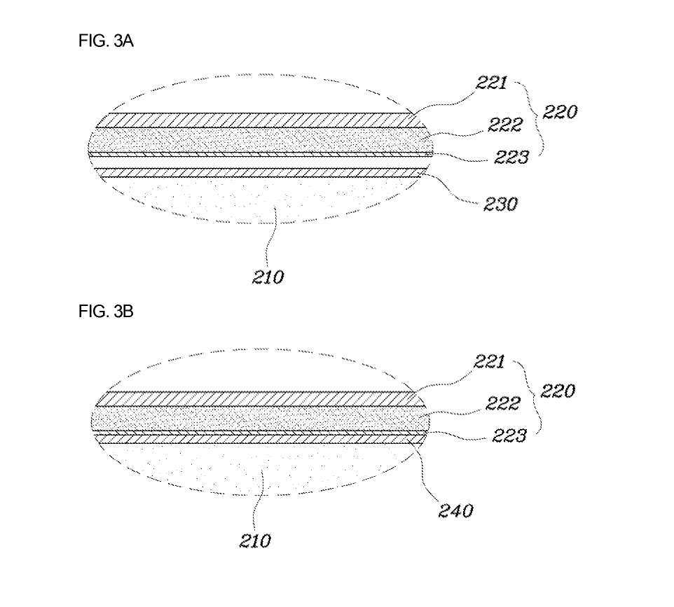

As shown in FIGS. 1 through 3B, a seat with a side airbag according to a first exemplary embodiment of the present invention is constructed such that a side seat cover 120 is reliably attached to the seat pad 210 so that when an airbag is deployed, the ability to tear a connection portion 101 formed between the front seat cover 110 and the side seat cover 120 can be enhanced.

In the present invention, an airbag module 130 which deploys an airbag cushion when a vehicle collision occurs is provided in the seat of the present invention. In detail, the airbag module 130 is installed in a seat pad 210 and includes the airbag cushion which is inflated and deployed in the lateral direction of the seat when a vehicle collision occurs.

The front seat cover 110 covers the front surface of the seat pad 210, and the side seat cover 120 covers the side surface of the seat pad 210. The front seat cover 110 includes an inner sheet 230 and an outer sheet 220, which covers the inner sheet 230. The side seat cover 120 includes only a single outer sheet 220.

As such, because the side seat cover 120 has only the outer sheet 220, the production cost and the work effort can be reduced, compared to a structure having a separate inner sheet. The reason the side seat cover 120 does not require a separate inner sheet is that the outer sheet 220 of the side seat cover 120 is fastened to the seat pad 210 by a fastening member 240 which will be explained later so that the fastening member 240 can play the role of the inner sheet, for example, it can function to guide the airbag cushion that is being deployed.

In the exemplary embodiment, the outer sheet 220 of the front seat cover 110 may comprise a fabric 221, a slab sponge 222 and a backing cloth 223, for example, of 15-denier. The outer sheet 220 of the side seat cover 120 may comprise a fabric 221, a slab sponge 222 and a backing cloth 223, such as loop Nylex. The backing cloth 223 of the side seat cover 120 is directly fastened to the seat pad 210 through the fastening member 240. Preferably, the backing cloth 223 is made of material which can be easily attached to the seat pad 210 through the fastening member 240. With regard to this, loop Nylex of the backing cloth 223 is material which can be easily fastened to the Velcro of the fastening member 240.

The front seat cover 110 and the side seat cover 120 are connected to each other through a connection portion 101. The connection portion 101 comprises a sewn portion which is formed by connecting the front seat cover 110 to the side seat cover 120 using a sewing yarn. When the airbag is deployed, the sewn portion is torn by inflation force of the airbag cushion and thus forms a passage through which the airbag cushion is deployed outwards.

Particularly, the outer sheet 220 of the side seat cover 120 is in close contact with the seat pad 210 and is fastened thereto by the fastening member 240. The fastening member 240 tightly fastens the side seat cover 120 to the seat pad 210, thus preventing the seat pad 210 and the side seat cover 120 from undesirably expanding due to the inflation force of the airbag cushion when the airbag is deployed.

In the exemplary embodiment, the fastening member 240 comprises an adhesive layer or Velcro tape. The adhesive layer or Velcro tape is easily attached to an adjacent element. For example, in the case of the use of the Velcro tape, the seat pad 210 is formed integrally with the Velcro tape. In the case of the use of the adhesive layer, the side seat cover 120 is made of material which adheres easily to the adhesive layer. When the airbag cushion is inflated, the deployment pressure of the airbag cushion is absorbed by the seat pad 210 and the side seat cover 120 through the fastening member 240 and is transmitted to the sewn portion between the front seat cover 110 and the side seat cover 120 to tear the sewn portion. By virtue of this structure, the ability to tear the connection portion 101 can be enhanced, and the deployment performance of the airbag cushion can be reliably ensured.

Furthermore, the adhesive layer or the Velcro tape extends a predetermined length on the side surface of the seat pad 210 in the front and rear direction of the seat. Preferably, several adhesive layers or pieces of Velcro tape are arranged at regular intervals in the heightwise direction of the seat and are parallel to each other. In detail, the adhesive layers are applied to the side surface of the seat pad 210 in the shape of bands which extend in the front and rear direction of the seat and are arranged in the heightwise direction of the seat such that they are parallel to each other. Thus, the side seat cover 120 can be fastened to the seat pad 210 by adhering it to the adhesive layers of the seat pad 210. In the case of the Velcro tapes, they are also provided on the side surface of the seat pad 210, extend in the front and rear direction of the seat, and are arranged parallel to each other at positions spaced apart from each other in the heightwise direction of the seat. Thus, the side seat cover 120 can be closely attached to the seat pad 210 by the Velcro tapes.

Hereby, the seat pad 210 can be effectively prevented from expanding forwards or backwards due to the inflation force of the airbag cushion when it is inflated in the seat pad 210.

Furthermore, a deployment notch 351 that faces the airbag module may be formed in the seat pad 210 to guide the airbag cushion such that it is deployed towards the connection portion 101.

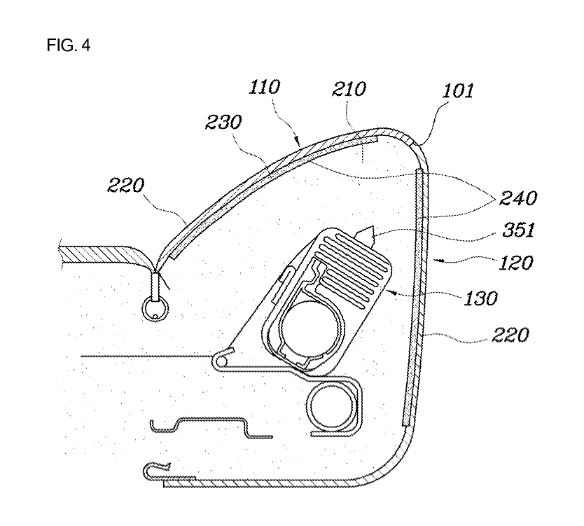

FIG. 4 illustrates a modification of the first exemplary embodiment of the present invention. As shown in FIG. 4, not only the outer sheet 220 of the side seat cover 120 but also the outer sheet 220 of the front seat cover 110 may be attached to the surface of the seat pad 210 by the fastening member 240. The fastening member 240 reliably fastens the front and side seat covers 110 and 120 to the seat pad 210, thus preventing the seat pad 210 and the side seat cover 120 from expanding due to the inflation force of the airbag cushion when it is deployed. Here, an adhesive layer or Velcro tape can be used as the fastening member 240. The explanation of the adhesive layer and Velcro tape remains the same as that of the first exemplary embodiment; therefore it will be omitted.

As such, in the present invention, the outer sheet 220 of the seat cover is fastened to the seat pad 210 by the adhesive layer or Velcro tape. Thus, the seat pad 210 and the side seat cover 120 are prevented from expanding due to the inflation force of the airbag cushion. In addition, the ability to tear the connection portion 101 can be enhanced, and the deployment performance of the airbag cushion can be reliably ensured.

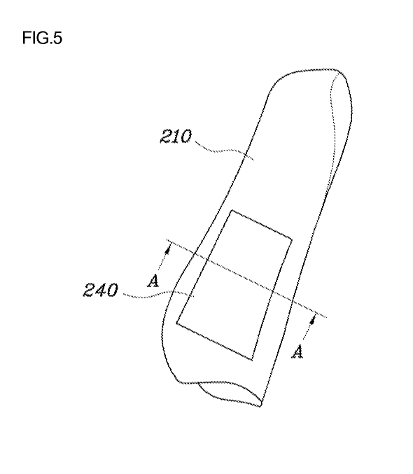

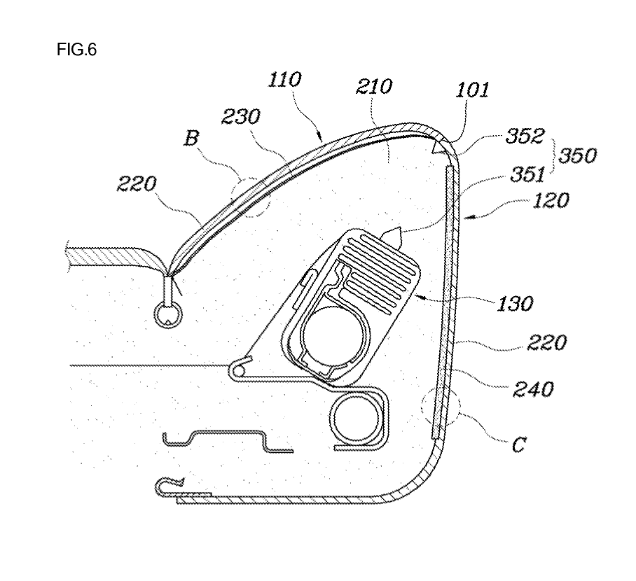

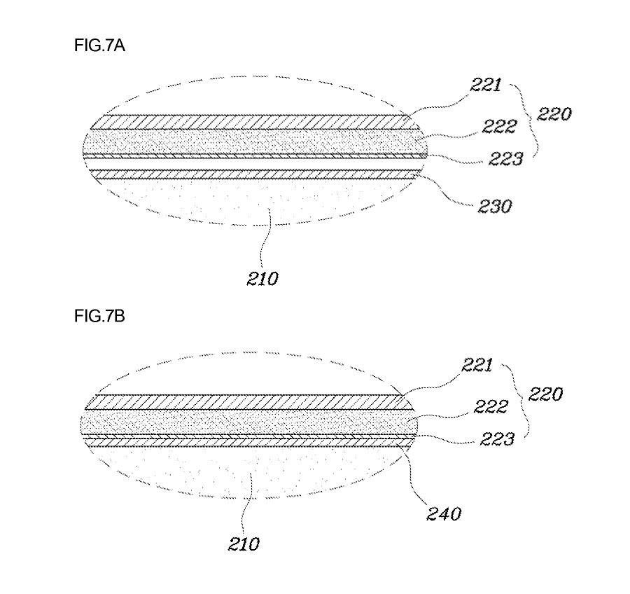

FIGS. 5 through 7B illustrate a second exemplary embodiment of the present invention. As shown in FIGS. 5 through 7B, in the second exemplary embodiment, a guide pad 240 having a relatively low elongation ratio is integrally formed on a seat pad 210. Thus, the seat pad 210 can be prevented from expanding due to inflation force of the airbag cushion when the airbag is deployed, and the deployment performance of the airbag cushion can be enhanced.

To realize the second exemplary embodiment, a seat with a side airbag includes the seat pad 210 which has an airbag module 130 therein, and a front seat cover 110 and a side seat cover 120 which cover the front surface and side surface of the seat pad 210 and are connected to each other through a connection portion 101. The side airbag seat further includes the guide pad 240 which is integrally formed on the seat pad 210 at a position facing the side seat cover 120.

In detail, the front surface of the seat pad 210 is covered with the front seat cover 110, and the side surface thereof is covered with the side seat cover 120. The front seat cover 110 comprises an inner sheet 230, and an outer sheet 220 which covers the inner sheet 230. The side seat cover 120 comprises only a single outer sheet 220.

As such, because the side seat cover 120 has only the outer sheet 220, the production cost and the work effort can be reduced, compared to a structure having a separate inner sheet. The reason the side seat cover 120 does not require a separate inner sheet is that the outer sheet 220 of the side seat cover 120 is fastened to the seat pad 210 by the guide pad 240 so that the guide pad 240 can play the role of the inner sheet, for example, it can function to guide the airbag cushion that is being deployed.

In the second exemplary embodiment, the outer sheet 220 of the front seat cover 110 and the outer sheet 220 of the side seat cover 120 may comprise a fabric 221, a slab sponge 222 and a backing cloth 223, for example, of 15-denier.

The front seat cover 110 and the side seat cover 120 are connected to each other by a connection portion 101. The connection portion 101 comprises a sewn portion which is formed by connecting the front seat cover 110 to the side seat cover 120 using a sewing yarn. When the airbag is deployed, the sewn portion is torn by inflation force of the airbag cushion and thus forms a passage through which the airbag cushion deploys outwards.

Particularly, to guide the airbag cushion that is being deployed towards the connection portion 101, notched portions 350 are formed in the seat pad 210. The notched portions 350 guide the airbag cushion such that it is deployed towards the connection portion 101. In detail, the notched portions 350 include a deployment notch 351 which is formed in the seat pad 210 and faces the airbag module, and a connection notch 352 which is formed in the seat pad 210 and faces the connection portion 101. The deployment notch 351 guides the position of the airbag cushion at an initial stage of the deployment of the airbag cushion. The connection notch 352 guides the airbag cushion in the seat pad 210 such that the airbag cushion is advanced towards the connection portion 101.

Therefore, when a vehicle collision occurs, the airbag cushion of the airbag module enters the seat pad through the deployment notch 351, and is guided towards the connection portion 101 by the connection notch 352, and then it is deployed outwards in the lateral direction of the seat.

Meanwhile, the guide pad 240 is integrally formed on the surface of the seat pad 210. The guide pad 240 is made of non-woven fabric having an elongation ratio lower than that of the seat pad 210. Preferably, the guide pad 240 is provided on the surface of the seat pad 210 at a position facing the side seat cover 120. Therefore, the guide pad 240 having a low elongation ratio can restrict the seat pad 210 having a relatively high elongation ratio from expanding due to the inflation force of the airbag cushion when it is deployed. Thus, the seat pad 210 and the side seat cover 120 can be prevented from expanding due to the deployment of the airbag cushion.

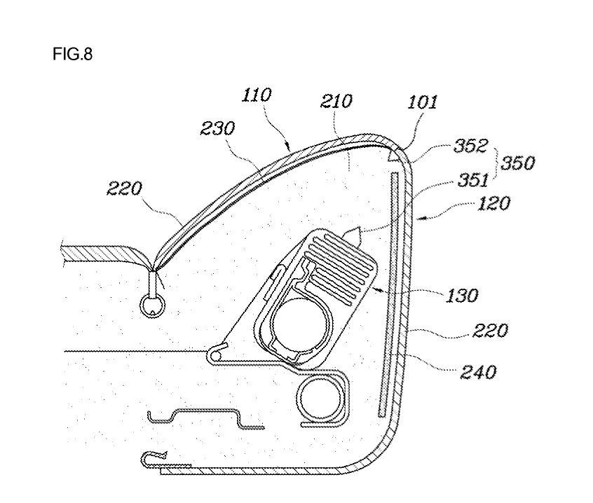

FIG. 8 illustrates a modification of the second exemplary embodiment of the present invention. As shown in FIG. 8, a guide pad 240 may be integrally formed in the seat pad 210. In this case, the guide pad 240 is formed along with the seat pad 210 when the seat pad 210 is formed by a foaming process. The guide pad 240 is disposed in the seat pad 210 at a position adjacent to the side seat cover 120. Hence, when the airbag cushion is deployed, the guide pad 240 can restrict the seat pad 210 from expanding due to the inflation force of the airbag cushion.

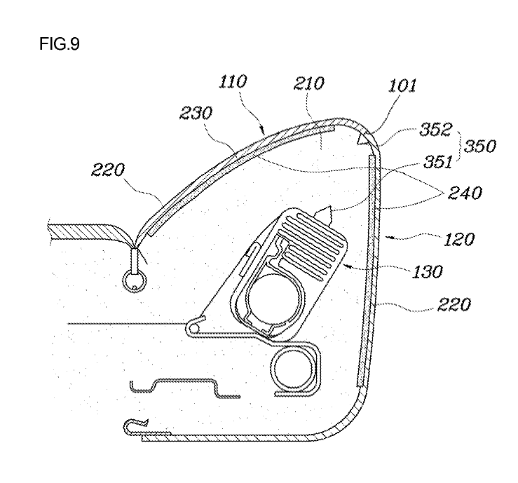

FIG. 9 illustrates another modification of the second exemplary embodiment of the present invention. As shown in FIG. 9, guide pads 240 may be integrally formed on the seat pad 210 at positions adjacent both to the side seat cover 120 and to the front seat cover 110. Here, the guide pads 240 may be formed on the surface of the seat pad 210 or, alternatively, it may be formed in the seat pad 210.

As such, in the case where the guide pads 240 are respectively formed on the seat pad 210 at positions corresponding both to the front seat cover 110 and the side seat cover 120, the seat pad 210 can be more reliably prevented from expanding due to the inflation force of the airbag cushion, and the airbag cushion can be more smoothly deployed.

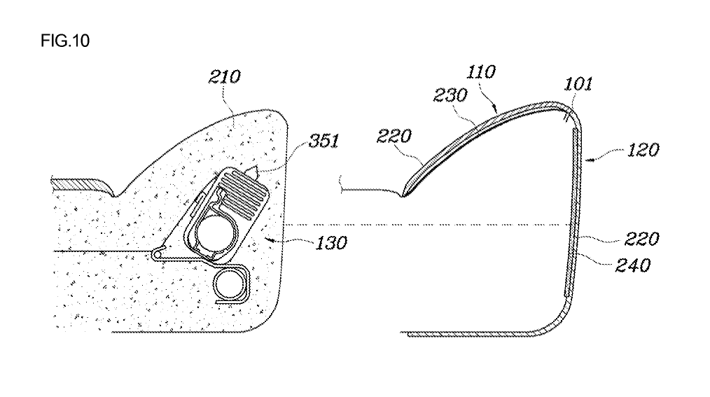

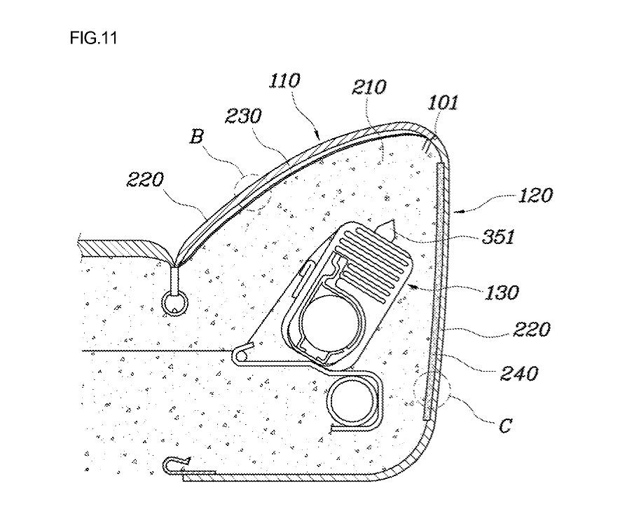

Meanwhile, as shown in FIGS. 10 and 11, in a seat with a side airbag according to a third exemplary embodiment of the present invention, a guide tape 240 is attached to a side seat cover 120 to guide the airbag cushion in the correct direction when it is deployed. Hereby, the ability to tear a connection portion 101 between a front seat cover 110 and a side seat cover 120 when the airbag is deployed can be enhanced.

To achieve this, the side airbag seat includes a seat pad 210, and an airbag module 130 which is disposed in the seat pad 210. The airbag module 130 is constructed such that an airbag cushion is inflated and deployed in the lateral direction of the seat when a vehicle collision occurs. The airbag module 130 has the same construction as that of a typical seat with a side airbag.

In an exemplary embodiment of the present invention, a deployment notch 351 that faces the airbag module may be formed in the seat pad 210 to guide the airbag cushion such that it is deployed towards the connection portion 101.

The front surface of the seat pad 210 is covered with the front seat cover 110, and the side and rear surfaces thereof are covered with the side seat cover 120. The front seat cover 110 and the side seat cover 120 are connected to each other through a connection portion 101. The connection portion comprises a sewn portion which is formed by connecting the front seat cover 110 to the side seat cover 120 using a thread. When the airbag is deployed, the sewn portion is torn by inflation force of the airbag cushion and thus forms a passage through which the airbag cushion is deployed outwards.

The front seat cover 110 comprises an inner sheet 230, and an outer sheet 220 which covers the inner sheet 230. The side seat cover 120 comprises only a single outer sheet 220.

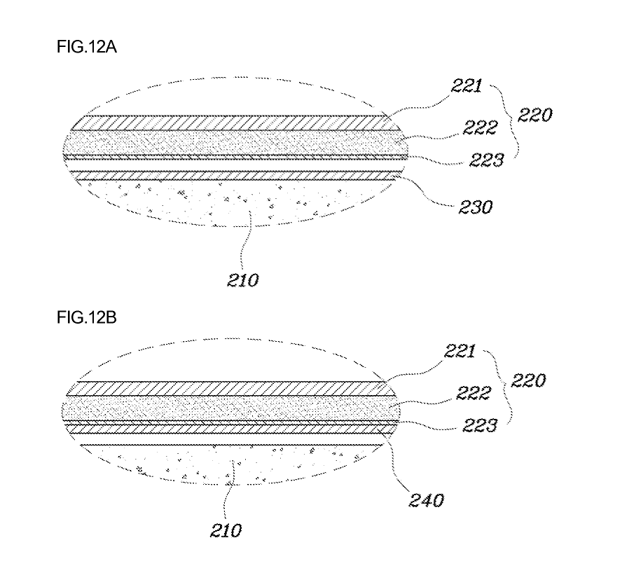

As shown in FIGS. 12A and 12B, the outer sheet 220 may comprise a fabric 221, a slab sponge 222 and a backing cloth 223. Here, the backing cloth of the side seat cover 120 is made of a non-woven fabric, preferably, loop Nylex. Loop Nylex is one kind of non-woven fabric, and poly Nylex or nylon Nylex is generally used as the loop Nylex. Loop Nylex is a material which is easily attached to the guide tape 240, such as a Velcro hook tape.

Therefore, in the case where the guide tape 240 is attached to the backing cloth 223 made of loop Nylex, the backing cloth 223 can be prevented from being torn by the inflation force of the airbag cushion when it is deployed. In addition, the airbag cushion that is being deployed can be reliably guided by the guide tape 240 towards the connection portion 101 formed between the front seat cover 110 and the side seat cover 120. As a result, when the airbag cushion is inflated, the deployment pressure of the airbag cushion is transmitted to the sewn portion formed on the junction between the front seat cover 110 and the side seat cover 120 and thus tears the sewn portion. Due to this structure, the ability to tear the connection portion 101 can be enhanced, and the deployment performance of the airbag cushion can be reliably ensured.

The guide tape 240 prevents the seat pad 210 and the side seat cover 120 from expanding when the airbag cushion is deployed by a vehicle collision. As well, the guide tape 240 functions to guide the airbag cushion such that it is deployed towards the connection portion 101 formed between the front seat cover 110 and the side seat cover 120. Preferably, the guide tape 240 is made of a Velcro hook tape which has a plurality of fine protruding hooks, so that the guide tape 240 is closely attached to the outer sheet 220 of the side seat cover 120. The Velcro hook tape can be easily attached to the backing cloth 223 made of loop Nylex. Due to the use of the Velcro tape, the guide tape 240 can be easily attached to or detached from the side seat cover 120.

To more reliably prevent the seat pad 210 and the side seat cover 120 from expanding when the airbag cushion is deployed, the guide tape 240 may comprise a plurality of guide tapes 240 which extend in the horizontal direction parallel to each other and are arranged at regular intervals in the heightwise direction of the seat pad 210.

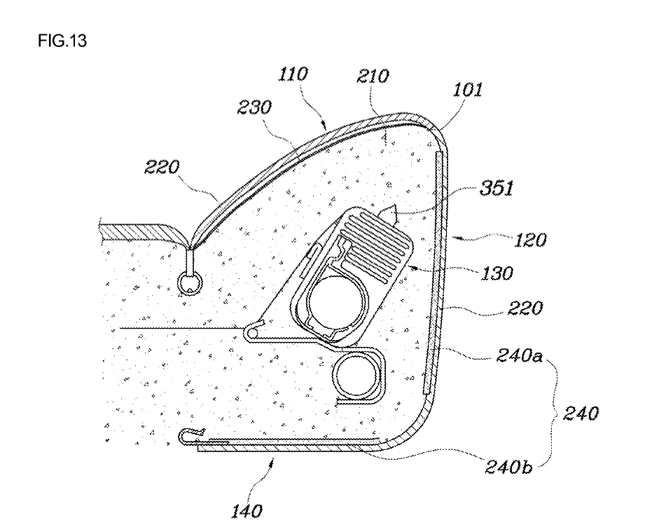

As shown in FIG. 13, the side seat cover 120 may comprise a side seat cover portion 220 which covers the side surface of the seat pad 210, and a rear seat cover portion 140 which covers the rear surface of the seat pad 210. Here, a backing cloth 223 of the side seat cover 120 is made of non-woven fabric, such as loop Nylex. A first guide tape 240a is attached to the side seat cover portion 120 and extends a predetermined length towards a connection portion 101 formed between the front seat cover 110 and the side seat cover 120. A second guide tape 240b is attached to the rear seat cover portion 140 and extends a predetermined length towards the side seat cover 120.

As such, in the present invention, the first and second guide tapes 240a and 240b which surround the side and rear surfaces of the seat pad 210 may be provided on the side seat cover 120. In this case, when the airbag cushion is deployed, the seat pad 210 and the side seat cover 120 can be more reliably prevented from expanding. In addition, the first and second guide tapes 240a and 240b can guide the airbag cushion such that it is deployed towards the connection portion 101 formed between the front seat cover 110 and the side seat cover 120.

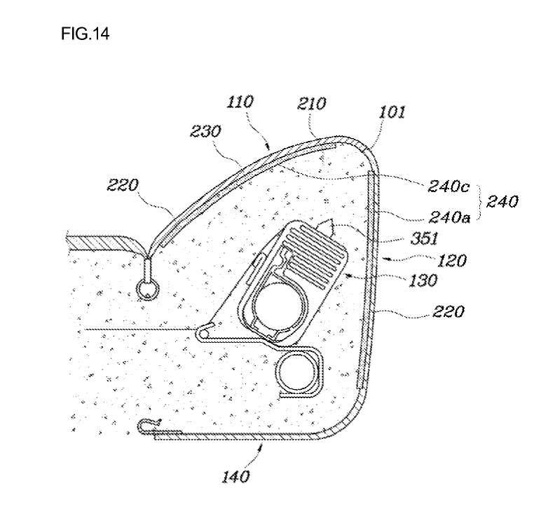

FIG. 14 illustrates a modification of the third exemplary embodiment of the present invention. As shown in FIG. 14, in this modification, the front surface of the seat pad 210 is covered with a front seat cover 110, and the side and rear surfaces thereof are covered with a side seat cover 120. Each of the front and side seat covers 110 and 120 comprises only a single outer sheet 220.

The outer sheet 220 comprises a fabric 221, a slab sponge 222 and a backing cloth made of non-woven fabric. A guide tape 240 is attached to the backing cloth. The guide tape 240 extends a predetermined length towards a connection portion 101 formed between the front seat cover 110 and the side seat cover 120. The guide tape 240 includes a first guide tape 240a which is attached to the side seat cover 120 and extends a predetermined length towards the connection portion 101 in the front and rear directions of the vehicle, and a third guide tape 240c which is attached to the front seat cover 110 and extends a predetermined length towards the connection portion 101.

As such, the present invention is constructed such that the guide tape 240 is attached to the seat cover, thus preventing the seat pad 210 or the side seat cover 120 from expanding due to inflation of the airbag cushion. Moreover, the ability to tear the connection portion 101 can be enhanced, and the deployment performance of the airbag cushion can be reliably ensured.

As described above, a first exemplary embodiment of the present invention is constructed such that an outer sheet of a seat cover is fastened to a seat pad by an adhesive layer or a Velcro tape. Therefore, the first exemplary embodiment does not require the inner sheet of the conventional technique, thus reducing the production cost. Furthermore, a process of applying an inner sheet to the seat is not required. Hence, the number of processes of manufacturing the seat and the work effort can be reduced.

In addition, in the first exemplary embodiment, several adhesive layers or Velcro tape extend predetermined lengths in the front and rear directions of the seat and are arranged parallel to each other at positions spaced apart from each other at regular intervals in the heightwise direction of the seat. Thus, the seat cover and the seat pad can be effectively prevented from expanding in the front and rear directions of the seat. As well, the ability to tear a connection portion of the seat can be enhanced, so that the airbag cushion can be smoothly deployed through the connection portion of the seat.

In a second exemplary embodiment of the present invention, a guide pad is integrally formed on the seat pad, thus preventing the seat pad from expanding due to inflation force of the airbag cushion when it is deployed. Furthermore, the guide pad can guide the airbag cushion such that it is smoothly deployed. The second exemplary embodiment also does not require a separate inner sheet, thus reducing the production cost and the work effort.

Moreover, in the second exemplary embodiment, when the airbag is deployed, the airbag cushion is guided by notched portions towards the connection portion formed between the front seat cover and the side seat cover. Therefore, the airbag cushion can be smoothly deployed.

In a third exemplary embodiment of the present invention, a guide tap which extends a predetermined length in the front and rear directions of the seat is attached to the seat. Thereby, the seat cover and the seat pad can be effectively prevented from expanding in the front and rear directions of the seat. The airbag cushion can be smoothly deployed through the connection portion of the seat which has the enhanced tearing performance.

For convenience in explanation and accurate definition in the appended claims, the terms “front”, “rear”, “outer”, and “inner” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A seat with a side airbag for a vehicle, comprising:
a seat pad containing an airbag module therein; and
a front seat cover for covering a front surface of the seat pad and a side seat cover for covering a lateral surface of the seat pad,
wherein an airbag cushion contained in the airbag module is deployed through a connection portion coupling one end portions of the front seat cover and the side seat cover when the connection portion is disconnected by the airbag cushion, and
wherein the front seat cover includes an inner sheet and an outer sheet covering the inner sheet, and the side seat cover includes a single outer sheet being brought into close contact with a lateral surface of the seat pad and fastened thereto by a fastening member.

2. The seat as set forth in claim 1, wherein the connection portion is formed at a corner of the seat pad in a forward direction of the seat.

3. The seat as set forth in claim 1, wherein a notched portion is formed in the seat pad on a path along which the airbag cushion is deployed towards the connection portion, the notched portion guiding the airbag cushion such that the airbag cushion is deployed towards the connection portion through the notched portion.

4. The seat as set forth in claim 1, wherein the fastening member comprises an adhesive layer or a Velcro tape coupling the seat pad and the single outer sheet of the side seat cover for preventing the seat pad or the seat cover from expanding due to lateral deployment force of the airbag cushion.

5. The seat as set forth in claim 4, wherein the Velcro tape is provided on the lateral surface of the seat pad or the single outer sheet of the side seat cover and extends in forward and rearward directions of the seat, and wherein the Velcro tape comprises a plurality of Velcro tapes arranged in parallel to each other and spaced apart from each other at predetermined intervals with respect to a heightwise direction of the seat.

6. A seat with a side airbag for a vehicle, comprising
a seat pad containing an airbag module therein; and
a front seat cover for covering a front surface of the seat pad and a side seat cover for covering a lateral surface of the seat pad,
wherein an airbag cushion contained in the airbag module is deployed through a connection portion coupling one end portions of the front seat cover and the side seat cover when the connection portion is disconnected by the airbag cushion, and
wherein a guide pad is integrally formed on the seat pad, the guide pad having an elongation ratio less than an elongation ratio of the seat pad.

7. The seat as set forth in claim 6, wherein the connection portion is formed at a corner of the seat pad in a forward direction of the seat.

8. The seat as set forth in claim 6, wherein
the front seat cover comprises an inner sheet and an outer sheet covering the inner sheet, and the side seat cover comprises a single outer sheet, and
the guide pad is provided on the lateral surface of the seat pad or inside the seat pad at a position facing the side seat cover.

9. The seat as set forth in claim 6, wherein
the front seat cover comprises an inner sheet and an outer sheet covering the inner sheet, and the side seat cover comprises a single outer sheet, and
the guide pad is provided on the lateral surface of the seat pad or inside the seat pad at a position facing the front seat cover.

10. The seat as set forth in claim 6, wherein a notched portion is formed in the seat pad on a path along which the airbag cushion is deployed towards the connection portion, the notched portion guiding the airbag cushion such that the airbag cushion is deployed towards the connection portion through the notched portion.

11. A seat with a side airbag for a vehicle, comprising:
a seat pad containing an airbag module therein; and
a front seat cover for covering a front surface of the seat pad and a side seat cover for covering a lateral surface of the seat pad,
wherein an airbag cushion contained in the airbag module is deployed through a connection portion coupling one end portions of the front seat cover and the side seat cover when the connection portion is disconnected by the airbag cushion, and
wherein a guide tape is attached to the side seat cover to guide a direction in which the airbag cushion is deployed, the guide tape extending a predetermined length towards the connection portion in a longitudinal direction of a vehicle.

12. The seat as set forth in claim 11, wherein the connection portion is formed at a corner of the seat pad in a forward direction of the seat.

13. The seat as set forth in claim 11, wherein a notched portion is formed in the seat pad on a path along which the airbag cushion is deployed towards the connection portion, the notched portion guiding the airbag cushion such that the airbag cushion is deployed towards the connection portion through the notched portion.

14. The seat as set forth in claim 11,
wherein the front seat cover comprises an inner sheet, and an outer sheet covering the inner sheet, and the side seat cover comprises a single outer sheet made of non-woven fabric, and
the guide tape comprises a Velcro hook tape having a plurality of fine protruding hooks, so that the guide tape is in close contact with the single outer sheet of the side seat cover and is fastened thereto by the fine protruding hooks.

15. The seat as set forth in claim 11,
wherein the front seat cover comprises a single outer sheet, and the side seat cover comprises a single outer sheet made of non-woven fabric, and
the guide tape comprises a Velcro hook tape having a plurality of fine protruding hooks, so that the guide tape is in close contact with the single outer sheet of the side seat cover and is fastened thereto by the fine protruding hooks.

16. The seat as set forth in claim 15, wherein the guide tape further includes a front guide tape attached to the front seat cover.

17. The seat as set forth in claim 11,
wherein the side seat cover further includes a rear seat cover portion covering a rear surface of the seat pad, and
the guide tape further includes a rear guide tape attached to the rear seat cover portion, the rear guide tape extending in a predetermined length along the rear surface of the seat pad.

18. The seat as set forth in claim 17, wherein the guide tape further comprises a front guide tape attached to the front seat cover.

19. The seat as set forth in claim 11, wherein the guide tape comprises a plurality of guide tapes attached to the side seat cover, the guide tapes being arranged parallel to each other and spaced apart from each other by predetermined intervals and in a heightwise direction of the seat pad.
